(19) United States
(12) Patent Application Publication
(10) Pub. No.: US 2004/0093607 A1
(43) Pub. Date: May 13, 2004

(54) System providing operating system independent access to data storage devices

(76) Inventor: Stephen J. Elliott, Sacramento, CA (US)

Correspondence Address: HEWLETT-PACKARD COMPANY, Intellectual Property Administration, P.O. Box 272400, Fort Collins, CO, 80527-2400, US

(21) Appl. No.: 10/282,851

(22) Filed: Oct. 29, 2002

(51) Int. Cl. G06F 15/16

(52) U.S. Cl. 719/326; 709/250

(57) ABSTRACT

The present invention provides an iSCSI interface allowing remote access to data storage devices directly and independent of a particular operating system. Conversion of control commands to SCSI commands and then to IP commands provides operating system independent access to the data storage devices. Access to separate portions of the data storage devices is also provided.

### FIELD OF THE INVENTION

The present invention relates generally to accessing data storage devices, and more particularly to a system providing operating system independent access to virtual disk storage networks, including data storage devices within storage area networks.

### BACKGROUND OF THE INVENTION

Management of stored information and efficient access to that information is increasingly more important. Systems are now required to maintain data at different locations each having different requirements (e.g., security settings) and to provide access to users at remote locations. With the increased use of portable devices such as, for example, laptop computers and personal digital assistants (PDA), each operating on different platforms and having different system requirements, ensuring compatibility to access information using different communication protocols and channels becomes even more difficult. Further, remote access using the Internet either directly or indirectly adds complexity to the process.

Use of the Internet to access and transfer data has resulted in the development of different standards, including communication and transfer standards. Users access the Internet to communicate with others and to check emails, as well as to access data, which may include sensitive information stored on remote storage devices. The Internet Small Computer System Interface (SCSI), often referred to as iSCSI is an Internet protocol (IP) based storage networking standard that provides for linking data storage facilities. Essentially, by carrying SCSI commands over IP networks, iSCSI facilitates data transfer over Internets and allows for management of storage systems from remote sites. Therefore, iSCSI provides increased capabilities and performance for storage data transmission, which is particularly useful in storage area networks (SANs). iSCSI also allows for transmission of data over different types of networks, including, for example, local area networks (LANs), wide area networks (WANs) or the Internet. Further, iSCSI provides for location independent data storage and retrieval.

High speed access and availability to stored data is typically of high importance not only for internal business operations, but also external e-commerce applications. However, physical storage devices are often separate and unique components within a network, with each typically having its own specific operating requirements. Further, unlike typical data-communication network hosts, storage devices are unable to initiate transactions. Thus, specific requests to the devices, for example, read or write requests must be made from other devices, such as, for example, servers or workstations. If a direct SCSI connection exists, a server can determine the available storage by accessing the SCSI bus connected to the particular storage device (e.g., disk array) of interest. However, in a storage network, for example, in a SAN, resources for the particular network are spread across a complex network. This causes numerous problems, including determining the location of specific devices, as well as the ownership of those particular devices. Thus, a server, for example, must be able to identify specific storage devices in the SAN, and determine whether access is permissible. Therefore, a determination of the available devices and access rights to those devices is required for proper operation.

SCSI allows host computer systems to configure block data input/output operations for use with different types of peripheral devices. These peripheral devices may include, for example, disk and tape devices, printers, scanners, CD ROM drives, optical storage devices, to name only a few. A traditional SCSI connection between a host system and peripheral device is provided using parallel cabling, which has distance and support limitations. SANs use SCSI protocol over network infrastructure to provide flexible high-speed block data transfers. iSCSI allows for block storage applications over TCP/IP networks. iSCSI essentially uses standard Ethernet switches and routers to communicate data between a server and storage devices. iSCSI also enables IP and Ethernet infrastructures to be implemented to access storage systems (e.g., SANs) and extend connectivity from remote locations. Thus, because iSCSI is provided over IP, existing infrastructure may be used for implementation.

In operation, when a user or application sends an iSCSI request, the operating system generates an appropriate operating system specific SCSI command and data request, which are then encapsulated and if necessary provided with encryption. A packet header is added before the IP packets are transmitted, for example, over an Ethernet connection. When the packet is received, it is decrypted and disassembled, with the operating system specific SCSI commands and requests separated from the packet. The operating system specific SCSI commands are transmitted to a SCSI controller and then to a SCSI storage device. Because iSCSI is bi-directional, the protocol allows for return data in response to the original request.

Known systems require a specialized iSCSI server specific to each operating system environment to provide the necessary functionality to access different data storage devices using the operating system specific SCSI commands. This adds extra cost and complexity to such a system. Further, different drivers and control systems are required for each different operating system, further complicating communication with and access to those systems

### SUMMARY OF THE INVENTION

The inventor of the present invention has perceived a need for a system providing a virtual machine and iSCSI interface that allows access (e.g., remote Internet access via a web-page) to storage independent of a particular operating system. By providing a machine/operating system independent interface, applications can access storage without having to determine particular system requirements.

The present invention generally provides a machine/operating system independent iSCSI interface that allows applications to access storage devices, for example, connected together and forming a SAN. Further, the present invention allows separate access to public information on public storage devices and private information on private storage devices.

In one embodiment, an interface for remotely accessing data storage devices of the present invention includes a first driver configured to convert control commands to SCSI commands, and a second driver configured to convert the SCSI commands to IP commands independent of an operating system for use in remotely accessing the data storage devices. The interface may include a virtual machine configured for operating the first and second drivers.

In another embodiment, a method of the present invention for providing remote access to data storage devices independent of an operating system includes converting control commands to SCSI commands, and converting the SCSI commands to IP commands independent of an operating system for use in remotely accessing the data storage devices. The method may include accessing separate portions of the data storage device using the converted commands. The method may also include providing a virtual machine for converting the commands.

Further areas of applicability of the present invention will become apparent from the detailed description provided hereinafter. It should be understood that the detailed description and specific examples, while indicating the preferred embodiments of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a block diagram of a system for accessing a Storage Area Network (SAN) in connection with which the present invention may be implemented;

FIG. 2 is a block diagram of an operating system independent interface constructed according to the principles of the present invention;

FIG. 3 is a block diagram of an operating system independent virtual machine of the operating system independent interface of the present invention showing access to separate portions of a SAN;

FIG. 4 is a block diagram showing access to a storage device using an operating system independent interface of the present invention;

FIG. 5 is a flowchart showing a process for accessing separate portions of a storage device according to the present invention;

FIG. 6 is an exemplary screen shot that may be provided by an operating system independent interface of the present invention; and

FIG. 7 is a flowchart showing a process for implementing the exemplary screen shot of FIG. 6.

### DETAILED DESCRIPTION OF THE PREFERRED EMBODIMENTS

The following description of the preferred embodiments is merely exemplary in nature and is in no way intended to limit the invention, its application, or uses. Thus, although the present invention is described in connection with specific component parts using particular drivers for providing operating system independent access to storage devices, it is not so limited, and different or additional component parts in connection with different or additional drivers may be implemented.

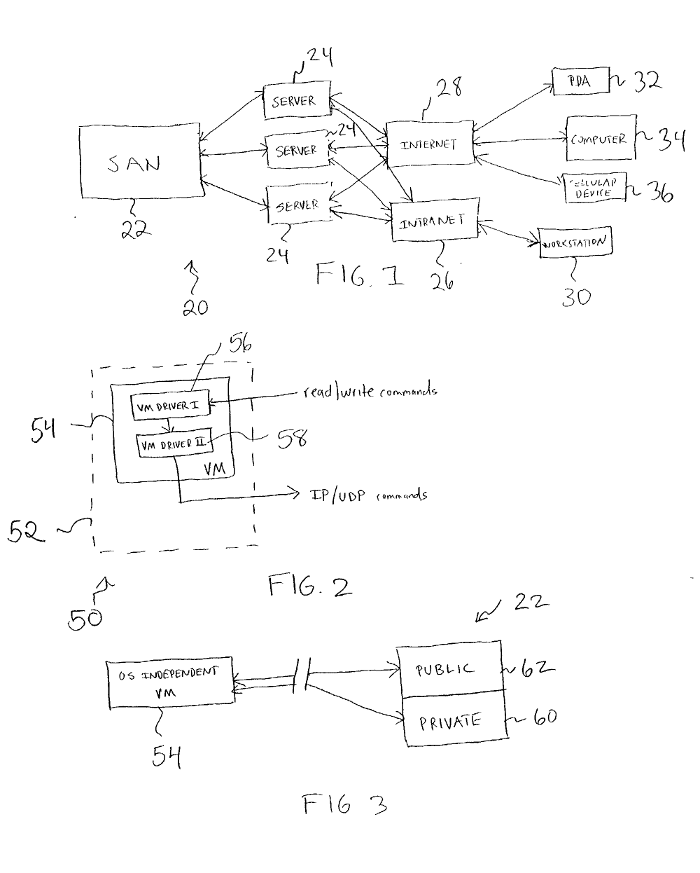

An exemplary system 20 for accessing data storage devices, such as in a Storage Area Network (SAN) 22, in connection with which the present invention may be implemented is shown generally in FIG. 1. The SAN 22, which may include different storage devices, is connected to servers 24, via for example, a dedicated fibre channel network, thereby allowing communication between any storage device within the SAN 22 and any server 24. The storage devices as part of the SAN 22 may include, for example, disk drives, optical storage devices (e.g., CD-ROM, CD-R/W, CD-R, or video disk), tape backup libraries, just a bunch of disks (JBODs), disk arrays, and array controllers. Further, multiple servers 24 may access the same storage device and storage devices can communicate with each other, thereby allowing backup without affecting the performance of the servers 24.

Data on the SAN 22 may be accessed using the servers 24, via for example, an intranet 26 or an internet 28. For example, using a workstation 30, a user may remotely access data on the SAN 22 via the intranet 26. Further, remote access to the data on the SAN 22 via the Internet 28 may be provided using, for example, a PDA 32, a computer 34 (e.g., laptop computer) or a cellular device 36 (e.g., cellular telephone or laptop computer having cellular capabilities). Thus, data access may be provided both internally via the intranet 26 and externally via the Internet 28. It should be noted that data may be stored on other types of storage networks and devices including, for example handheld storage on cellular phones and personal data organizers, ftp or web folders accessed through a software or hardware bridge, and network-mounted storage (e.g., a network file system (NFS)).

Having described an exemplary system 20 in connection with which the present invention may be implemented, one embodiment of the present invention will now be described. In general, the present invention provides an iSCSI interface 50 configured, for example, as a server/client web-page 52 that operates independent of a particular operating system for accessing stored data. The iSCSI interface 50 includes a virtual machine 54 (e.g., Java virtual machine) having a first driver 56 and a second driver 58. More particularly, the first driver 56 within the virtual machine 54 is configured to convert control commands, such as, for example, SCSI commands for reads and writes, inquiry commands, sense commands, and open and close commands to SCSI commands. The second driver 58 (i.e., an iSCSI driver) within the virtual machine 54 is configured to convert SCSI commands to Internet commands such as, for example, Internet Protocol (IP) or Internet Protocol/User Datagram Protocol (IP/UDP) commands that interface to IP as a stand alone system or via a web-page. The drivers 56 and 58 are configured such that web-pages can access storage directly over the Internet (e.g., via IP on UDP) independent of a particular operating system.

In one embodiment, the drivers 56 and 58 are embedded into programming language libraries, such as, for example, on JAVA or VBSCRIPT across operating system platforms. In operation, a web server page using these libraries may access storage on other systems using the iSCSI interface 50 as shown in FIG. 4. As shown therein, the operating system independent virtual machine 54, using a programming language library 70, or alternately using a plug-in 72 accesses a server 24 via, for example, an Ethernet 76. The Ethernet 76 provides connection to a particular storage device 78, which may be provided as part of the SAN 22 and/or may be a virtual device.

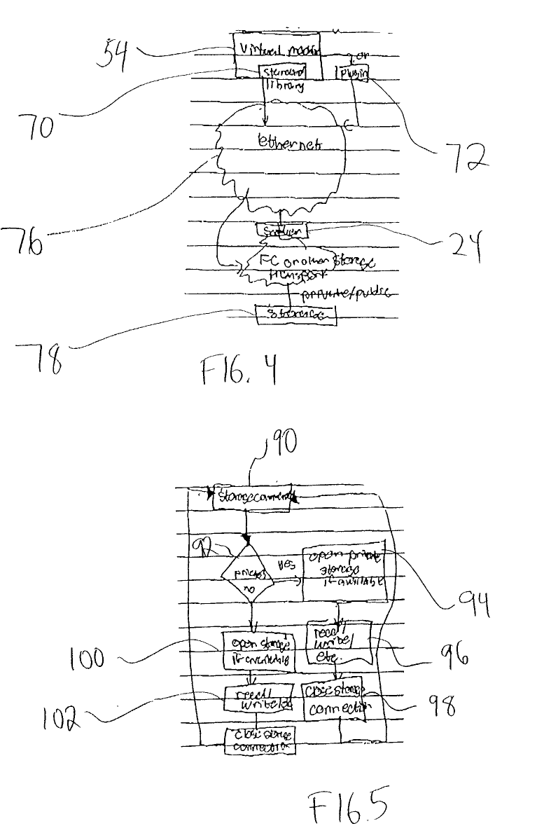

Further, and as shown in FIG. 3, an operating system independent virtual machine 54 allows division of data on a storage device and/or the SAN 22 into separate portions, such as, for example, a private storage portion 60 and a public storage portion 62. With respect to providing separate portions and limiting access thereto, as shown in FIG. 5, a storage command (e.g., user requesting access to a storage device 78) is executed at 90. A determination is made at 92 as to whether the request for access is to the private storage portion 60 or public storage portion 62. If the request is for access to the private storage portion 60, then at 94, the private storage portion 60 is accessed (e.g., open a connection) if available, for example, based upon the authorized security level of the user requesting access, which may be determined using a login procedure. If the private storage portion 60 is available at 94, then at 96, the appropriate commands are performed (e.g., reads and writes), and at 98, the storage connection is closed. If at 92 it is determined that the request is for access to the public storage portion 62, then at 100, the public storage portion 62 is accessed (e.g., open a connection) if available, for example, based upon the authorized security level of the user requesting access, which may be determined using a login procedure. If the public storage portion 62 is available at 100, then at 102, the appropriate commands are performed (e.g., reads and writes), and at 104, the storage connection is closed.

With respect to using the operating system independent virtual machine 54, and for example, a user may access a web-page 110 as shown in FIG. 6 for sending an email to a telephone audience (e.g., a predetermined group of telephone numbers). It should be noted that in this example, a cellular telephone acts as the storage device with the web-page 110 displayed on a display of the cellular telephone. A test box 112 is provided for entering a message using, for example, the keys of the cellular telephone. Thereafter, when the user pushes a send button 114 on the web-page 110, the selected devices (i.e., cellular phones in the predetermined group of telephone numbers) are opened (e.g., telephone connection established) and the message is sent. Thereafter, the devices are closed.

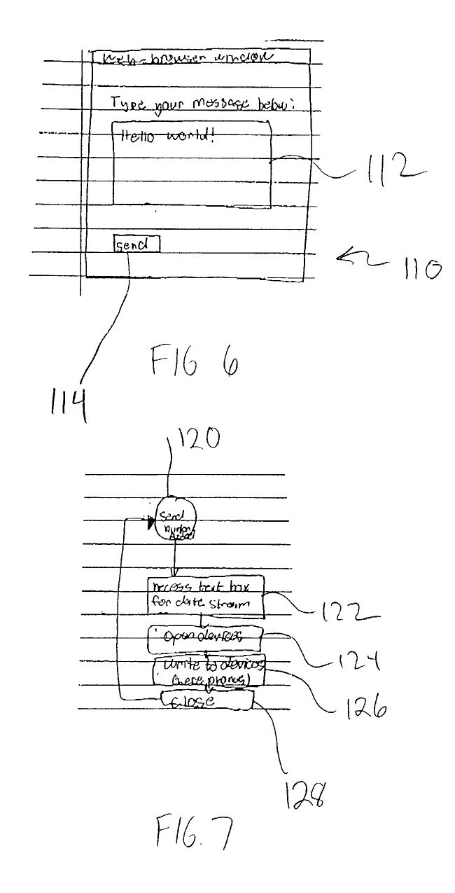

Thus, as shown in FIG. 7, at 120 the web-page 110 is accessed and at 122 the text box 112 is accessed for providing a message (i.e., a data stream). At 124, the selected devices are opened, which are cellular telephones in this example, and the data stream is written to the selected devices at 126. Thereafter, at 128, the selected devices are closed.

In operation, the present invention provides an iSCSI interface 50 having a virtual machine 54 (e.g., Java virtual machine) capable of operation on different operating systems independent of, for example, a particular protocol. Using a virtual machine 54 of the present invention, access to virtual disk drives (e.g., private storage portion 60 and a public storage portion 62 of a SAN 22) is provided without having to execute a particular operating system or a particular plug-in. In particular, the iSCSI interface 50 provides higher level operating system commands that are converted to SCSI commands and allow redrive operations locally to a particular drive (e.g., network drive). Thus, a particular applet or web application is not needed.

Specifically, in one embodiment of the iSCSI interface 50 having the virtual machine 54, the iSCSI layer is directly accessed by a web-page with an embedded command within the web-page. Thus, one web-page can open, read or write to devices or provide authentication using direct low-level commands. The resulting data transfer can be provided between a variable within the script and a web-object. Specifically, in order to provide the iSCSI interface 50 to allow for system independent access to storage devices, the following is performed:

(1) Identify the sequence of low-level SCSI-layer or iSCSI-layer commands that are to be issued.

(2) Identify objects on the web-page that require data exchange to the storage devices.

(3) Identify methods and mechanisms for data reformatting a translation of data formats.

(4) Provide script-language code that accesses these SCSI or iSCSI-level commands. These commands may be predefined access commands in standard libraries that access the low-level commands to perform the same functions in a more direct manner. Further, these commands may be accessed through, for example, the common gateway interface (CGI) or a PERL script on the server side.

(5) A user can then initiate data exchange by working through the programming interface.

It should be noted that the server-side may have access to storage that is not accessible by the client. For example, on an order form, the server may access all customer orders for a day, whereas the client accesses “cookies” that have information about all the customer's orders.

Thus, the present invention provides protocol and operating system independent access to data storage devices using, for example, virtualization of disk storage. The present invention also provides for access to separate portions of the virtual storage. Further, using iSCSI, a secure link may be provided, for example, to access sensitive information, which is separate from control operations.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. An interface for remotely accessing data storage devices comprising:
a first driver configured to convert control commands to SCSI commands; and
a second driver configured to convert the SCSI commands to IP commands independent of an operating system for use in remotely accessing the data storage devices.

2. The interface according to claim 1 wherein the control commands comprise one of a read and write command.

3. The interface according to claim 1 wherein the IP commands comprise UDP commands.

4. The interface according to claim 1 wherein the first and second drivers are configured to provide access to separate portions of the data storage devices.

5. The interface according to claim 1 wherein the data storage devices are configured as a SAN.

6. The interface according to claim 1 further comprising a virtual machine configured for operating the first and second drivers.

7. The interface according to claim 1 wherein the virtual machine comprises a Java virtual machine.

8. A method of providing remote access to data storage devices independent of an operating system comprising:
converting control commands to SCSI commands; and
converting the SCSI commands to IP commands independent of an operating system for use in remotely accessing the data storage devices.

9. The method according to claim 8 further comprising accessing separate portions of the data storage device using the converted commands.

10. The method according to claim 8 wherein the control commands are one of read and write commands.

11. The method according to claim 8 wherein the IP commands comprise UDP commands.

12. The method according to claim 8 further comprising providing a virtual machine for converting the commands.

13. The method according to claim 8 further comprising configuring a web-page for operating the virtual machine.

14. The method according to claim 8 wherein the data storage devices are configured as a SAN.

15. A method for remotely accessing data storage devices via an internet and independent of an operating system comprising:
converting control commands to SCSI commands; and
converting the SCSI commands to commands for use in connection with the internet and independent of an operating system for remotely accessing the data storage devices

16. The method according to claim 15 wherein the commands for use in connection with the internet comprise IP commands.

17. The method according to claim 16 wherein the IP commands comprise UDP commands.

18. The method according to claim 15 further comprising providing a virtual machine for converting the commands using drivers.

19. The method according to claim 18 wherein the drivers comprise a first driver for converting the control commands to SCSI commands and a second driver for converting the SCSI commands to commands for use in connection with the internet.

20. The method according to claim 19 wherein the virtual machine is configured for operation in connection with a web-page.
